(19) United States
(12) Patent Application Publication
(10) Pub. No.: US 2008/0178237 A1
(43) Pub. Date: Jul. 24, 2008

(54) INFORMATION-PROCESSING DEVICE, AUDIOVISUAL DISTRIBUTION SYSTEM AND AUDIOVISUAL DISTRIBUTION METHOD

(76) Inventor: KIYOSHI HASHIMOTO, Tokyo (JP)

Correspondence Address: NEC CORPORATION OF AMERICA, 6535 N. STATE HWY 161, IRVING, TX, 75039, US

(21) Appl. No.: 12/015,617

(22) Filed: Jan. 17, 2008

(30) Foreign Application Priority Data
Jan. 24, 2007 (JP) 013755/2007

(51) Int. Cl. H04N 7/173

(52) U.S. Cl. 725/109

(57) ABSTRACT

An information-processing device transmitting an audiovisual distribution start request mutually with another information-processing device to, thereby, start the audiovisual distribution or reception including: a distribution request part that transmits the distribution start request to another information-processing device; a distribution response part that transmits a distribution start response for the distribution start request from another information-processing device to the another information-processing device; and a distribution control part that controls the distribution request part or the distribution response part upon start of the audiovisual distribution or reception to regulate transmission of the distribution start request or the distribution start response.

### INCORPORATION BY REFERENCE

This application is based upon and claims the benefit of priority from Japanese patent applications No. 2007-013755, filed on Jan. 24, 2007, the disclosure of which is incorporated herein its entirety by reference.

### BACKGROUND OF THE INVENTION

1. Field of the Invention

The present invention relates to an information-processing device, an audiovisual distribution system and an audiovisual distribution method.

2. Description of the Related Art

Normally in the case of the related art observing local weather and road traffic state across the nation, cameras and encoders encoding video and audio captured with cameras are installed in each area and a decoder in a headquarter decodes video and audio distributed from the encoders.

As the related art for audiovisual distribution, technologies called FPU (Field Pick-up Unit) with radio waves are prevailing. However, nowadays technologies with an IP network are also present.

As an audiovisual distribution system with an IP network for audiovisual distribution, an audiovisual distribution system, for example, establishing a TCP (Transmission Control Protocol) session between an encoder and a decoder and distributing an audiovisual stream as a UDP (User Datagram Protocol) packet from the encoder to the decoder is included (see patent document 1 (Japanese Patent Laid-Open No. 2005-333568)).

Here, in an audiovisual distribution system as disclosed in patent document 1, normally audiovisual stream distribution start request from a decoder to an encoder is carried out to start the audiovisual steam distribution from the encoder to the decoder.

However, two-way transmission can be carried out easily between the encoder and the decoder through an IP network. Therefore, needs for carrying out distribution start requests are deemed to increase from local decoders in the case where local weathers and road traffic states, for example, change significantly.

However, in the case where the encoder and the decoder are both simply designed to make distribution start request, it is considered that the case where a plurality of distribution start requests compete against each other occurs more frequently.

For example, the case includes the case of transmitting distribution start requests from a plurality of decoders to one encoder; the case of transmitting distribution start requests from a plurality of encoders to one decoder; and the case of transmitting distribution start requests mutually between a pair of decoder and encoder approximately at the same time.

In order to arbitrate in the case where a plurality of distribution start requests compete against each other in an audiovisual distribution system, it is considered to provide a distribution server as disclosed in patent document 2 (Japanese Patent Laid-Open No. 2005-323309), for example, which arbitrates in distribution start requests.

However, the case where the distribution server is provided as disclosed in patent document 2 gives rise to such an adverse effect that the entire system increases in cost.

As described above, a related audiovisual distribution system presents a problem that a distribution server for arbitrating among a plurality of distribution start requests has to be provided on assumption that a plurality of distribution start requests compete against each other in order to configure the system in which both an encoder and a decoder both make distribution start requests.

### SUMMARY

Therefore, an exemplary object of the invention is an information-processing device, an audiovisual distribution system and an audiovisual distribution method that can arbitrate among a plurality of distribution start requests without providing a distribution server, in the case where a plurality of distribution start requests compete against each other.

An exemplary aspect of the invention is an information-processing device transmitting an audiovisual distribution start request mutually with another information-processing device to, thereby, start the audiovisual distribution or reception, including: a distribution request part that transmits the distribution start request to another information-processing device; a distribution response part that transmits a distribution start response for the distribution start request from another information-processing device to the another information-processing device; and a distribution control part that controls the distribution request part or the distribution response part upon start of the audiovisual distribution or reception to regulate transmission of the distribution start request or the distribution start response.

An exemplary aspect of the invention is an audiovisual distribution system including a plurality of information-processing devices mutually transmit audiovisual distribution start requests to, thereby, start the audiovisual distribution or reception, wherein each of the plurality of information-processing devices includes a distribution request part that transmits the distribution start request to another information-processing device; a distribution response part that transmits a distribution start response for the distribution start request from another information-processing device to the another information-processing device; and a distribution control part that controls the distribution request part or the distribution response part upon start of the audiovisual distribution or reception to regulate transmission of the distribution start request or the distribution start response.

An exemplary aspect of the invention is an audiovisual distribution method in an information-processing device including: mutually transmitting audiovisual distribution start requests with another information-processing device to, thereby, start the audiovisual distribution or reception, wherein the information-processing device includes: a distribution request part transmitting the distribution start request to another information-processing device; a distribution response part transmitting a distribution start response for the distribution start request from another information-processing device to the another information-processing device; and a distribution control part controlling the distribution request part and the distribution response part, and the method including: regulating transmission of the distribution start request or the distribution start response upon start of the audiovisual distribution or reception by the distribution control part.

An exemplary aspect of the invention is a recording medium that records a program for an audiovisual distribution method in an information-processing device mutually transmitting audiovisual distribution start requests with another information-processing device to, thereby, start the audiovisual distribution or reception, wherein the information-processing device includes a distribution request part transmitting the distribution start request to another information-processing device; a distribution response part transmitting a distribution start response for the distribution start request from another information-processing device to the another information-processing device; a distribution control part controlling the distribution request part and the distribution response part; and a recording medium recording the program; and wherein a program is stored in the recording medium for causing the distribution control part to regulate transmission of the distribution start request or the distribution start response upon start of the audiovisual distribution or reception.

### BRIEF DESCRIPTION OF THE DRAWINGS

FIG. 1 is a block diagram of a first exemplary embodiment of the present invention;

FIG. 2 is a block diagram of a second exemplary embodiment of the present invention;

FIG. 3 is a block diagram illustrating a configuration of the encoder illustrated in FIG. 2;

FIG. 4 is a block diagram illustrating a configuration of the decoder illustrated in FIG. 2;

FIG. 5 is a flow chart describing operations in the case where one decoder makes a distribution start request in the audiovisual distribution system illustrated in FIG. 2;

FIG. 6 is a flow chart describing a TCP state of an encoder and a decoder for a period up to a step S9 illustrated in FIG. 5;

FIG. 7 is a flow chart describing operations in the case where one encoder makes a distribution start request in the audiovisual distribution system illustrated in FIG. 2;

FIG. 8 is a flow chart describing operations in the case where two decoders make distribution start requests in the audiovisual distribution system illustrated in FIG. 2;

FIG. 9 is a flow chart describing operations in the case where two encoders make distribution start requests in the audiovisual distribution system illustrated in FIG. 2; and

FIG. 10 is a flow chart describing operations in the case where an encoder and a decoder both make distribution start requests mutually approximately at the same time in the audiovisual distribution system illustrated in FIG. 2.

### EXEMPLARY EMBODIMENT

An exemplary embodiment of the invention will be described with reference to the drawings.

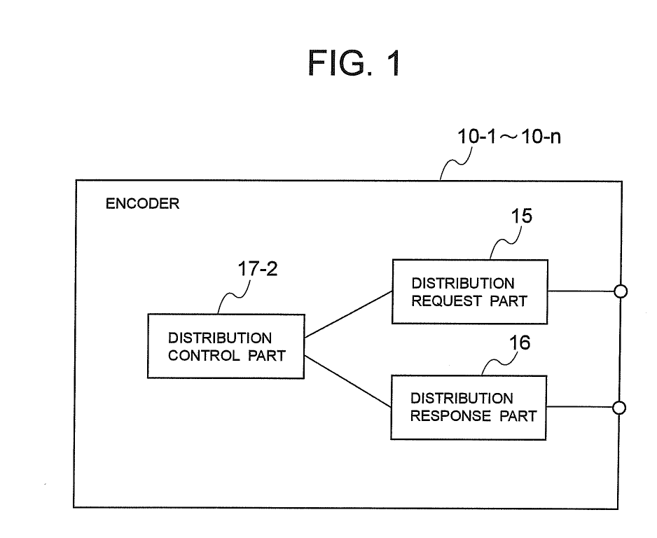

At first, a first exemplary embodiment will be described. FIG. 1 is a block diagram of the first embodiment of the present invention.

With reference to FIG. 1, an information-processing device (encoders 10-1 to 10-n) of a first exemplary embodiment transmitting an audiovisual distribution start request mutually with another information-processing device to, thereby, start the audiovisual distribution or reception, including: a distribution request part 15 transmitting the distribution start request to another information-processing device; a distribution response part 16 transmitting a distribution start response for the distribution start request from another information-processing device to the another information-processing device; and a distribution control part 17-2 controlling the distribution request part 15 or the distribution response part 16 upon start of the audiovisual distribution or reception to regulate transmission of the distribution start request or the distribution start response.

According to the above described configuration, each of a plurality of information-processing devices 10 is provided with a distribution request part 15 transmitting a distribution start request; a distribution response part 16 transmitting a distribution start response for the distribution start request; and a distribution control part 17-2 controlling the distribution request part or the distribution response part upon start of the audiovisual distribution or reception to regulate transmission of the distribution start request or the distribution start response; and each information-processing device 10 arbitrates in a plurality of distribution start requests.

Therefore, even in the case where a plurality of distribution start requests compete against each other, arbitration among a plurality of distribution start requests can be carried out without providing a distribution server.

Specifically, the distribution control part 17-2 controls the distribution response part 16 to restrain transmission of a distribution start response in the case where its own device 10 transmits a distribution start request to start audiovisual distribution or reception.

In addition, the distribution control part 17-2 controls the distribution request part 15 to restrain transmission of a distribution start request in the case where its own device 10 transmits a distribution start response to start audiovisual distribution or reception.

In addition, the distribution control part 17-2 receives a distribution start request from another information-processing device 10 besides audiovisual distribution destination or distribution source and then controls the distribution response part 16 to transmit a distribution rejection response to the another information-processing device 10 in the case where its own device 10 transmits a distribution start response to start audiovisual distribution or reception.

In addition, the distribution control part 17-2 controls the distribution request part 15 to notify another information-processing device 10 to interrupt transmission of a distribution start request in the case where the another information-processing device 10 being the transmission destination of the distribution start request establishes a communication session with its own device prior to transmission of a distribution start request from its own device 10.

As described above, a first exemplary advantage according to the invention is that because the first exemplary embodiment is configured so that each information-processing device 10 arbitrates among a plurality of distribution start requests, arbitration among a plurality of distribution start requests can be carried out without providing a distribution server even in the case where a plurality of distribution start requests compete against each other.

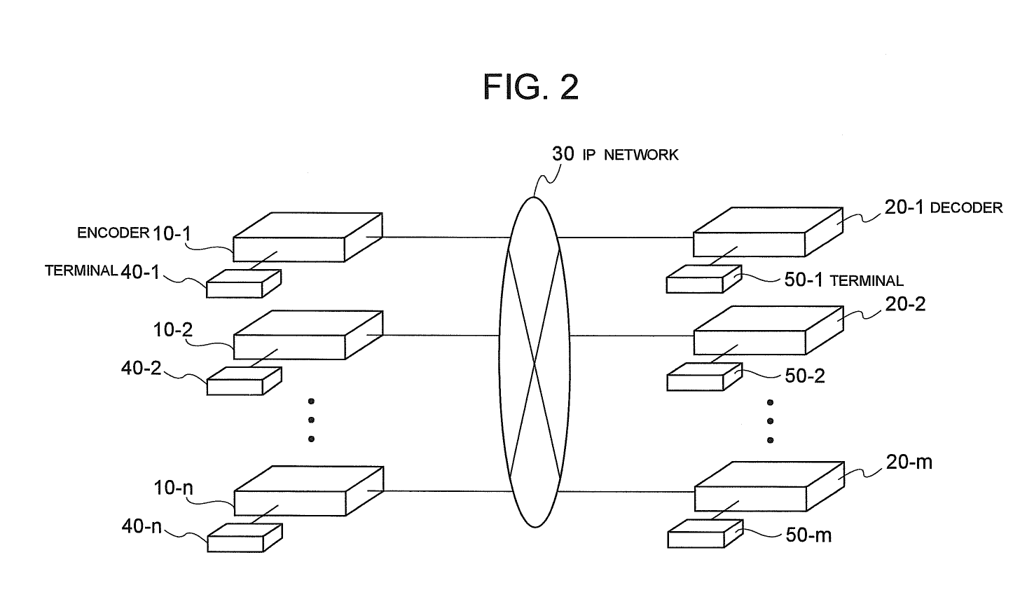

Next, a second exemplary embodiment will be described. FIG. 2 is a drawing illustrating a configuration of an audiovisual distribution system of the second exemplary embodiment of the present invention.

With reference to FIG. 2, the audiovisual distribution system of the second exemplary embodiment is configured to include n (n being a natural number) units of encoders 10-1 to 10-n and m (m being a natural number) units of decoders 20-1 to 20-m being brought into connection with each other through an IP network 30.

In addition, the terminals 40-1 to 40-n are respectively connected to the encoders 10-1 to 10-n in a corresponding manner. In addition, terminals 50-1 to 50-m are respectively connected to the decoders 20-1 to 20-m in a corresponding manner.

The encoders 10-1 to 10-n establish one-to-one communication session with any one of the decoders 20-1 to 20-m and transmit a distribution start request of an audiovisual stream to that decoder to start distribution of an audiovisual stream.

On the other hand, the decoders 20-1 to 20-m establish one-to-one communication session with any one of the encoders 10-1 to 10-m and transmit a distribution start request of an audiovisual stream to that encoder to start reception of an audiovisual stream distributed from that encoder.

Here, in the second exemplary embodiment, the communication session is described as a TCP session. In addition the audiovisual stream is described to be distributed as a UDP packet. However, the present invention will not be limited thereto.

In addition, the audiovisual stream is described as coded data and uncompressed (PCM; Pulse Code Modulation) data represented by MPEG2-TS (Moving Picture Experts Group phase 2-Transport Stream). However, the present invention will not be limited thereto.

The encoders 10-1 to 10-n and the decoders 20-1 to 20-m enter a distribution start request wait state after a startup and respond with a distribution start response in the case of receiving, in a distribution start request wait state, a distribution start request from another device.

The encoders 10-1 to 10-n and the decoders 20-1 to 20-m recognize its own device as a master station (master) to enter a distribution state or a reception state respectively in the case where its own device transmits a distribution start request and recognize its own device as a slave station (slave) to enter a distribution state or a reception state respectively in the case where its own device responds with a distribution start response.

The master station (master) restrains, in a distribution state or a reception state, a distribution start response in order to reject a distribution start request from another device.

On the other hand, the slave station restrains, in a distribution state or a reception state, transmission of a distribution start request from its own device.

Moreover, the slave station (slave), in a distribution state or a reception state, receives a distribution start request from another device and, then, carries out a distribution rejection response in order to notify that the line is occupied.

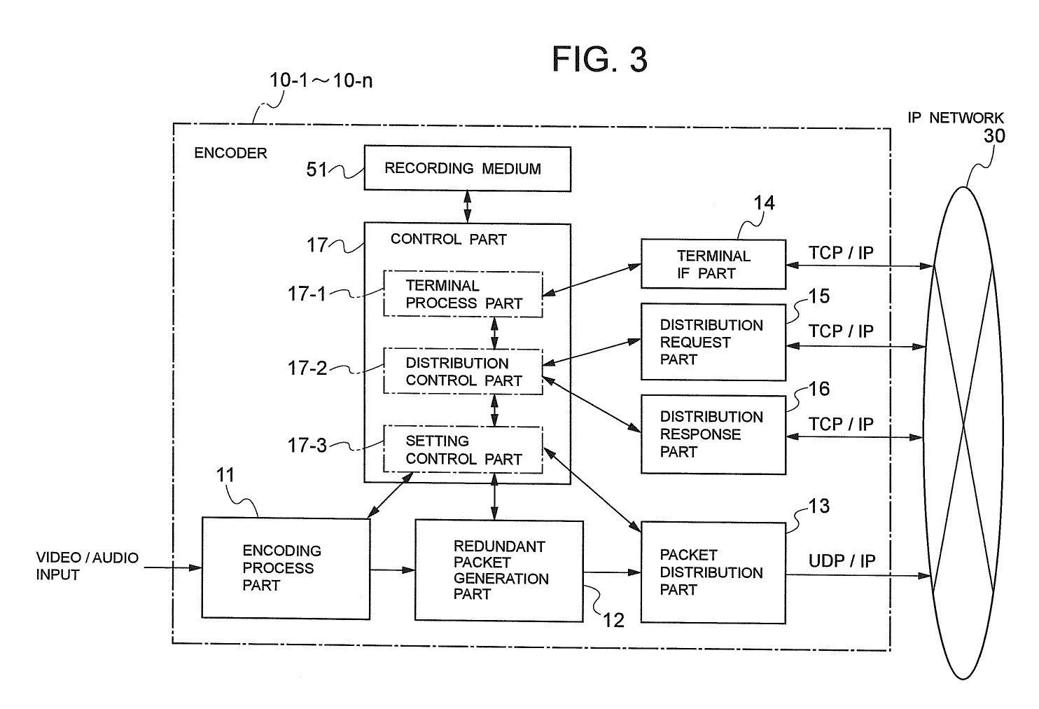

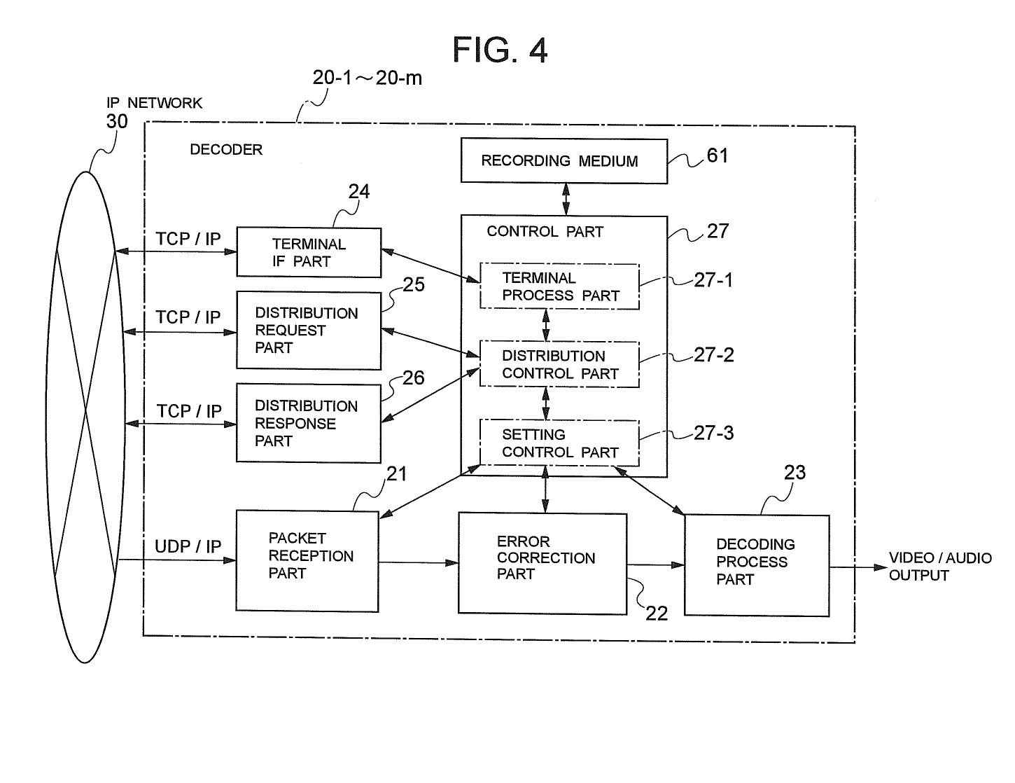

Here, internal configurations of encoders 10-1 to 10-n and decoders 20-1 to 20-m will be described with reference to FIG. 3 and FIG. 4. FIG. 3 is a block diagram illustrating a configuration of the encoder illustrated in FIG. 2 and FIG. 4 is a block diagram illustrating a configuration of the decoder illustrated in FIG. 2.

With reference to FIG. 3, each of the encoders 10-1 to 10-n includes an encoding process part 11, redundant packet (FEC; Forward Error Correction) generation part 12, a packet distribution part 13, a terminal IF (Interface) part 14, a distribution request part 15, a distribution response part 16, a control part 17 and a recording medium 51.

The encoding process part 11 encodes a digital video/audio signal input from outside into MPEG2-TS data and packets the post-encoding MPEG2-TS data.

The redundant packet generation part 12 generates a redundant packet (FEC) for error correction based on the MPEG2-TS data encoded in the encoding process part 11.

The packet distribution part 13 distributes the MPEG2-TS data packet from the encoding process part 11 onto the IP network 30 together with the redundant packet from the redundant packet generation part 12.

The terminal IF part 14 is an interface portion with a terminal provided corresponding to its own device.

The distribution request part 15 transmits a distribution start request and the like onto the IP network 30 under control of the control part 17. In addition, the distribution response part 16 transmits a distribution start response and the like onto the IP network 30 under control of the control part 17.

The control part 17 controls entire operations of the encoder 10 and includes a terminal process part 17-1, a distribution control part 17-2 and a setting control part 17-3.

The terminal process part 17-1 processes an input from a terminal provided corresponding to its own device to process notification to that terminal.

The distribution control part 17-2 controls the distribution request part 15 and the distribution response part 16 and, for example, regulates transmission of a distribution start request or a distribution start response in a distribution state.

Specifically, the distribution control part 17-2 receives distribution start instruction from a terminal in a distribution start request wait state and, then, controls the distribution request part 15 to transmit a distribution start request.

In addition, the distribution control part 17-2 receives a distribution start request from another terminal in a distribution start request wait state and, then, controls the distribution response part 16 to respond with a distribution start response.

Here, the distribution control part 17-2 controls, in a distribution state, the distribution response part 16 to restrain transmission of a distribution start response if its own device is a master station (master).

In addition, the distribution control part 17-2 controls, in a distribution state, the distribution request part 15 to restrain transmission of a distribution start request and controls the distribution response part 16 to carries out a distribution rejection response if its own device is a slave station (slave).

The setting control part 17-3 controls setting on the encoding process part 11, the redundant packet generation part 12 and the packet distribution part 13.

Specifically, the setting control part 17-3 sets an encoding mode in the encoding process part 11, sets a redundant packet generation interval in the redundant packet generation part 12, and sets a distribution address in the packet distribution part 13 corresponding to instruction from a terminal.

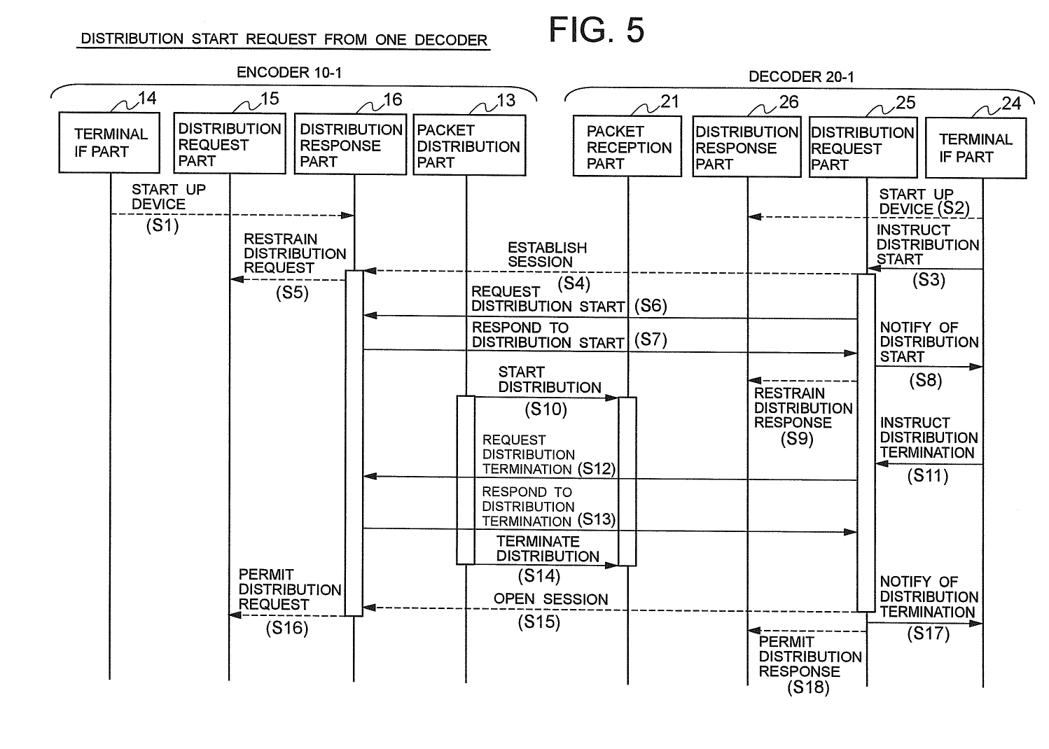

The recording medium 51 stores programs illustrated in the form of flow charts in FIGS. 5 to 10 to be described later. The control part 17 reads those programs from the recording medium 51 to control respective parts 11 to 16 according to those programs.

With reference to FIG. 4, each of the decoders 20-1 to 20-m includes a packet reception part 21, an error correction part 22, a decoding process part 23, a terminal IF part 24, a distribution request part 25, a distribution response part 26, a control part 27 and a recording medium 61.

The packet reception part 21 receives, from the IP network 30, a packet transmitted from the encoders 10-1 to 10-n.

In the case where lack (lack of packet) takes place in the MPEG2-TS data packet received by the packet reception part 21, the error correction part 22 carries out error correction in order to restore the lacked packet based on the redundant packet received by the packet reception part 21.

The decoding process part 23 decodes the MPEG2-TS data into a digital video/audio signal to output to outside.

The terminal IF part 24, the distribution request part 25 and the distribution response part 26 operate likewise the terminal IF part 14, the distribution request part 15 and the distribution response part 16 inside the encoders 10-1 to 10-n. Therefore, description thereof will be omitted.

The control part 27 controls entire operations of the decoder 20 and includes a terminal process part 27-1, a distribution control part 27-2 and a setting control part 27-3. Among these, the terminal process part 27-1 operates likewise the terminal process part 17-1 inside the encoders 10-1 to 10-n. Therefore, description thereof will be omitted.

The distribution control part 27-2 controls the distribution request part 25 and the distribution response part 26 and, for example, regulates transmission of a distribution start request or a distribution start response in a reception state.

Specifically, the distribution control part 27-2 receives distribution start instruction from a terminal in a distribution start request wait state and, then, controls the distribution request part 25 to transmit a distribution start request.

In addition, the distribution control part 27-2 receives a distribution start request from another terminal in a distribution start request wait state and, then, controls the distribution response part 26 to respond with a distribution start response.

Here, the distribution control part 27-2 controls, in a reception state, the distribution response part 26 to restrain transmission of a distribution start response if its own device is a master station (master).

In addition, the distribution control part 27-2 controls, in a reception state, the distribution request part 25 to restrain transmission of a distribution start request and controls the distribution response part 26 to carry out a distribution rejection response if its own device is a slave station (slave).

The setting control part 27-3 controls setting on the packet reception part 21, the error correction part 22 and the decoding process part 23.

Specifically, the setting control part 27-3 sets a reception address in the packet reception part 21, sets an interval for carrying out the error correction process in the error correction part 22, and sets a decoding mode in the decoding process part 23 corresponding to instruction from a terminal.

The recording medium 61 stores programs illustrated in the form of flow charts in FIGS. 5 to 10 to be described later. The control part 27 reads those programs from the recording medium 61 to control respective parts 21 to 26 according to those programs.

Operations of an audiovisual distribution system of the second exemplary embodiment will be described below.

### (Distribution Start Request From One Decoder)

At first, operations in the case where one decoder makes a distribution start request will be described. Here, with reference to FIG. 5, operations in the case where the decoder 20-1 makes a distribution start request to the encoder 10-1 will be described as an example.

At first, in the encoder 10-1, the distribution response part 16 enters a distribution start request wait state when its own device is started up (step S1).

Likewise, in the decoder 20-1, the distribution response part 26 enters a distribution start request wait state when its own device is started up (step S2).

Here, a TCP session is established between the distribution request part 25 of the decoder 20-1 and the distribution response part 16 of the encoder 10-1 (step S4) when a terminal 50-1 makes distribution start instruction in the decoder 20-1 (step S3).

In response, in the encoder 10-1, transmission of the distribution start request by the distribution request part 15 is restrained (step S5).

Subsequently, in the decoder 20-1, the distribution request part 25 transmits a distribution start request to the encoder 10-1 (step S6). In the encoder 10-1, the distribution response part 16 transmits a distribution start response to the decoder 20-1 (step S7).

In response, in the decoder 20-1, the distribution request part 25 carries out distribution start notification to the terminal 50-1 (step S8). In addition, transmission of the distribution start response by the distribution response part 26 is restrained (step S9).

Subsequently, the MPEG2-TS data is distributed as a UDP packet from the packet distribution part 13 of the encoder 10-1 to the packet reception part 21 of the decoder 20-1 (step S10).

Thereafter, when the terminal 50-1 makes distribution termination instruction (step S11), the distribution request part 25 in the decoder 20-1, transmits a distribution termination request to the encoder 10-1 (step S12). The distribution response part 16 in the encoder 10-1 transmits a distribution termination response to the decoder 20-1 (step S13).

Subsequently, distribution of the MPEG2-TS data from the packet distribution part 13 of the encoder 10-1 to the packet reception part 21 of the decoder 20-1 is terminated (step S14). A TCP session is opened between the distribution request part 25 of the decoder 20-1 and the distribution response part 16 of the encoder 10-1 (step S15).

In response, in the encoder 10-1, transmission of the distribution start request by the distribution request part 15 is permitted (step S16).

On the other hand, in the decoder 20-1, the distribution request part 25 carries out distribution termination notification to the terminal 50-1 (step S17). In addition, transmission of the distribution start response by the distribution response part 26 is permitted (step S18).

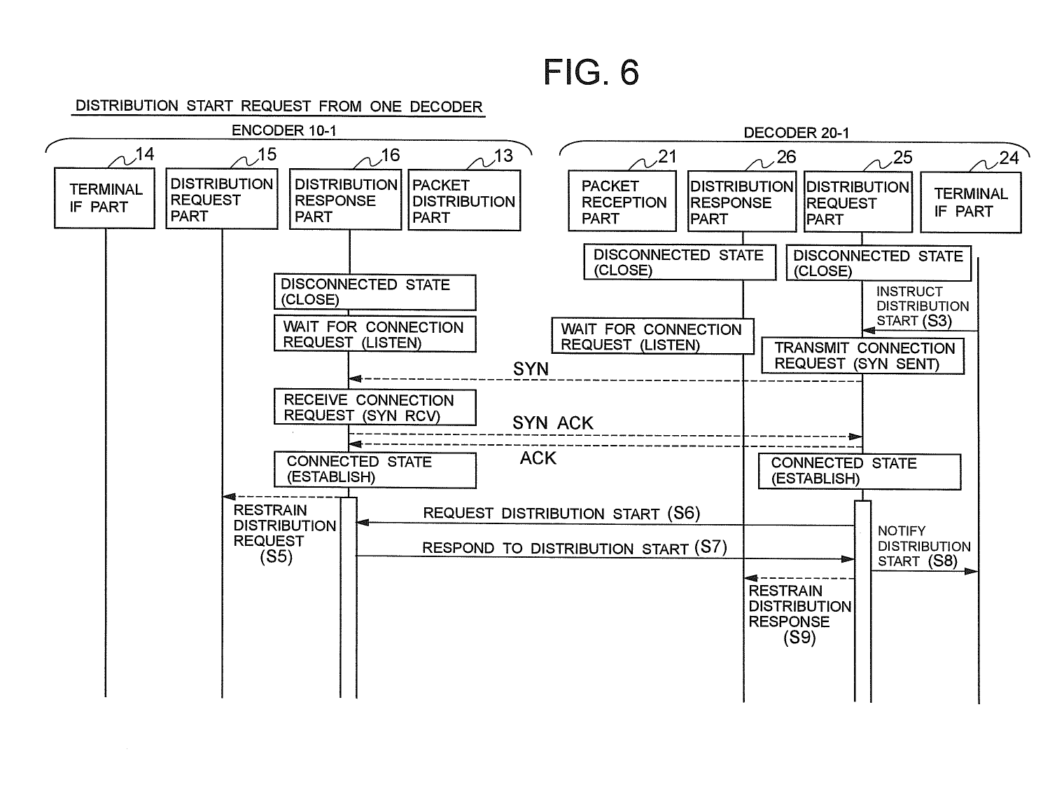

Here, the TCP state of the encoder 10-1 and the decoder 20-1 up to the step S9 illustrated in FIG. 5 is illustrated in FIG. 6.

### (Distribution Start Request From One Encoder)

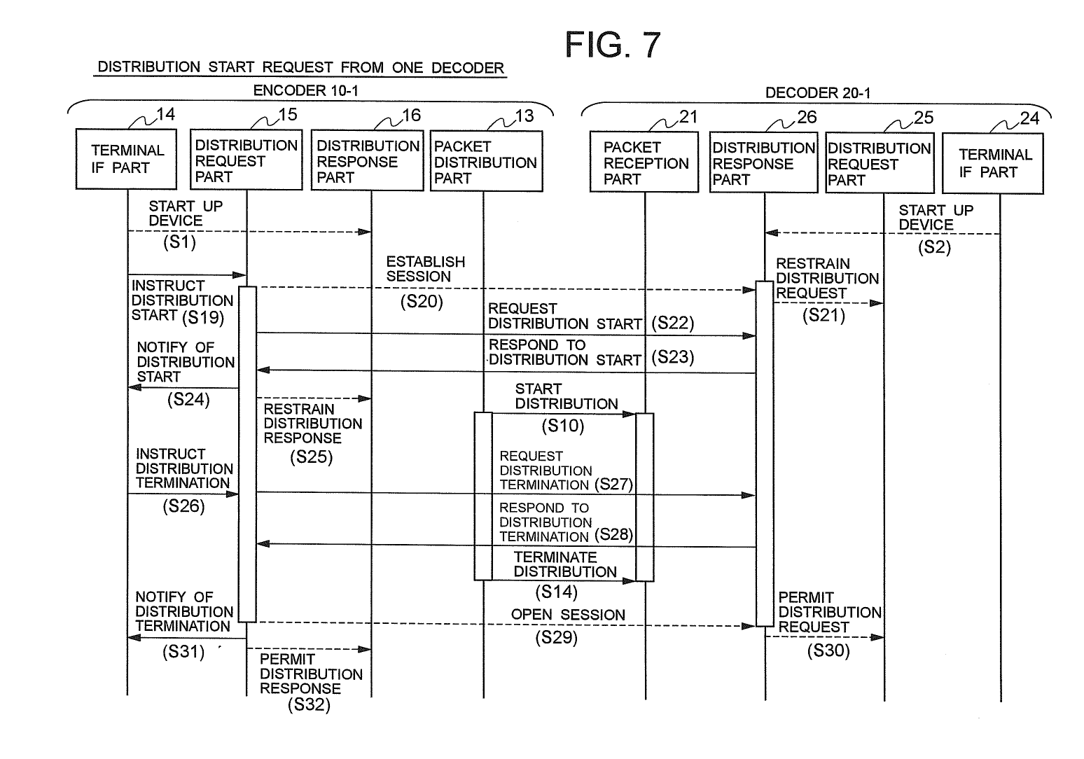

Next, operations in the case where one encoder makes a distribution start request will be described. Here, with reference to FIG. 7, the case where the encoder 10-1 makes a distribution start request to the decoder 20-1 will be described as an example.

At first, in the encoder 10-1, the distribution response part 16 enters a distribution start request wait state when its own device is started up (step S1).

Likewise, in the decoder 20-1, the distribution response part 26 enters a distribution start request wait state when its own device is started up (step S2).

Here, a TCP session is established between the distribution request part 16 of the encoder 10-1 and the distribution response part 26 of the decoder 20-1 (step S20) when a terminal 40-1 makes distribution start instruction in the encoder 10-1 (step S19).

In response, in the decoder 20-1, transmission of the distribution start request by the distribution request part 25 is restrained (step S21).

Subsequently, in the encoder 10-1, the distribution request part 15 transmits a distribution start request to the decoder 20-1 (step S22). In the decoder 20-1, the distribution response part 26 transmits a distribution start response to the encoder 10-1 (step S23).

In response, in the encoder 10-1, the distribution request part 15 carries out distribution start notification to the terminal 40-1 (step S24). In addition, transmission of the distribution start response by the distribution response part 16 is restrained (step S25).

Subsequently, the MPEG2-TS data is distributed as a UDP packet from the packet distribution part 13 of the encoder 10-1 to the packet reception part 21 of the decoder 20-1 (step S10).

Thereafter, when the terminal 40-1 makes distribution termination instruction (step S26), the distribution request part 15 in the encoder 10-1, transmits a distribution termination request to the decoder 20-1 (step S27). The distribution response part 26 in the decoder 20-1 transmits a distribution termination response to the encoder 10-1 (step S28).

Subsequently, distribution of the MPEG2-TS data from the packet distribution part 13 of the encoder 10-1 to the packet reception part 21 of the decoder 20-1 is terminated (step S14). A TCP session is opened between the distribution request part 15 of the encoder 10-1 and the distribution response part 26 of the decoder 20-1 (step S29).

In response, in the decoder 20-1, transmission of the distribution start request by the distribution request part 25 is permitted (step S30).

On the other hand, in the encoder 10-1, the distribution request part 15 carries out distribution termination notification to the terminal 40-1 (step S31). In addition, transmission of the distribution start response by the distribution response part 16 is permitted (step S32).

### (Distribution Start Requests From a Plurality of Decoders)

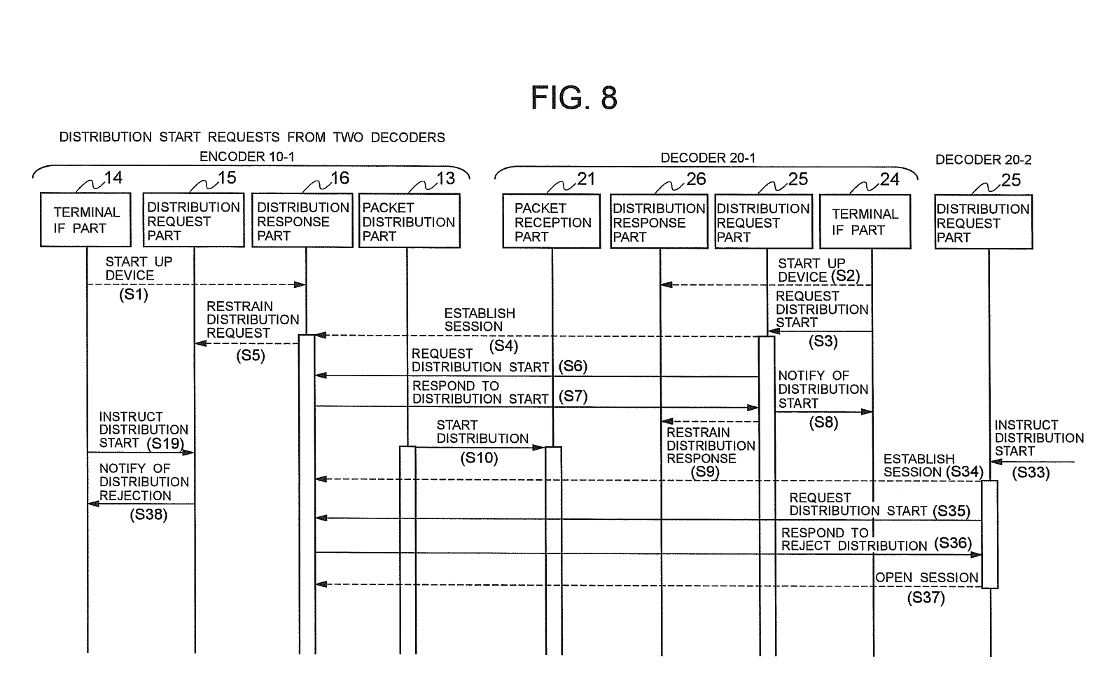

Next, operations in the case where a plurality of decoders makes distribution start requests will be described. Here, with reference to FIG. 8, operations in the case where two decoders 20-1 and 20-2 make distribution start requests to the encoder 10-1 will be described as an example.

At first, likewise in FIG. 5, the process up to the step S10 is carried out and the encoder 10-1 distributes the MPEG2-TS data to the decoder 20-1.

Here, suppose the terminal 50-2 makes a distribution start instruction in another decoder 20-2 (step S33). Then a TCP session is established between the distribution request part 25 of the decoder 20-2 and the distribution response part 16 of the encoder 10-1 (step S34).

Subsequently, in the decoder 20-2, the distribution request part 25 transmits a distribution start request to the encoder 10-1 (step S35).

At that time, since the encoder 10-1 is in a distribution state, the distribution response part 16 transmits a distribution rejection response to the decoder 20-2 (step S36).

Therefore, a TCP session is opened between the distribution request part 25 of the decoder 20-2 and the distribution response part 16 of the encoder 10-1 (step S37).

In addition, suppose the terminal 40-1 makes distribution start instruction in the encoder 10-1 (step S19).

At that time, in the encoder 10-1, the step S5 restrains transmission of a distribution start request by the distribution request part 15. Therefore, the distribution request part 15 carries out distribution rejection notification to the terminal 40-1 (step S38).

As described above, in the present exemplary embodiment, in the case where another decoder 20-2 makes a distribution start request to the encoder 10-1 as well when the encoder 10-1 is distributing an audiovisual stream to the decoder 20-1 after the decoder 20-1 has made a distribution start request to the encoder 10-1, the encoder 10-1 rejects distribution to the decoder 20-2 which makes a distribution start request afterwards to, thereby, enable arbitration among a plurality of distribution start requests.

In addition, in the case of receiving distribution start instruction again from the terminal 40-1, the encoder 10-1 can reject the distribution start instruction.

### (Distribution Start Requests From a Plurality of Encoders)

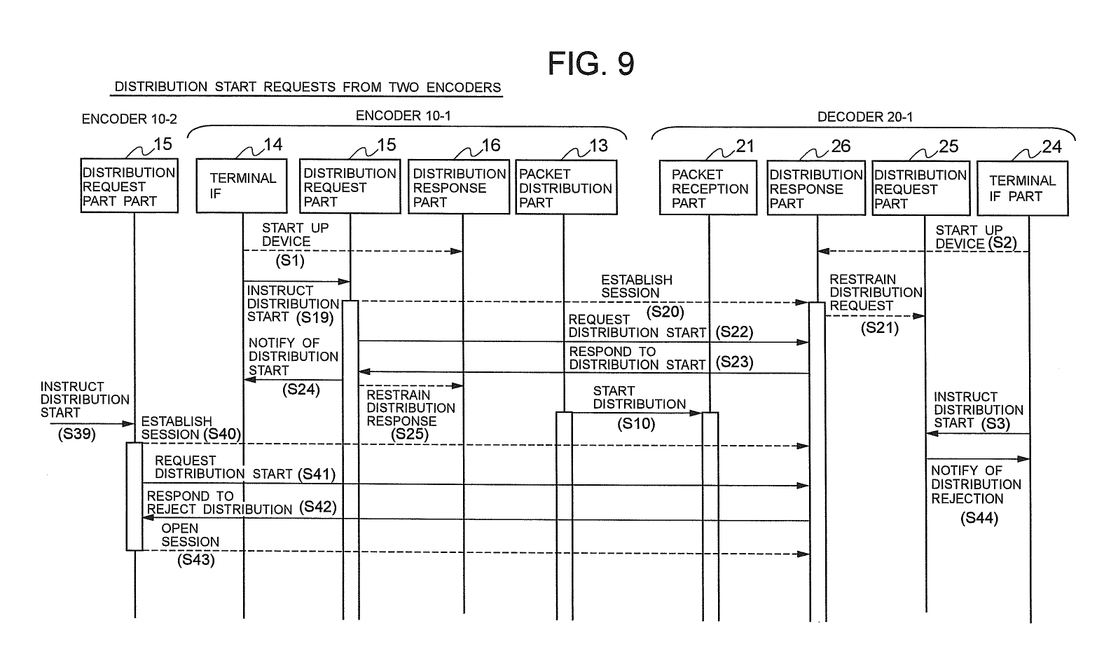

Next, operations in the case where a plurality of encoders makes distribution start requests will be described. Here, with reference to FIG. 9, operations in the case where two encoders 10-1 and 10-2 make distribution start requests to the decoder 20-1 will be described as an example.

At first, likewise in FIG. 7, the process up to the step S10 is carried out and the encoder 10-1 distributes the MPEG2-TS data to the decoder 20-1.

Here, suppose the terminal 40-2 makes a distribution start instruction in another encoder 10-2 (step S39). Then a TCP session is established between the distribution request part 15 of the encoder 10-2 and the distribution response part 26 of the decoder 20-1 (step S40).

Subsequently, in the encoder 10-2, the distribution request part 15 transmits a distribution start request to the decoder 20-1 (step S41).

At that time, since the decoder 20-1 is in a reception state, the distribution response part 26 transmits a distribution rejection response to the encoder 10-2 (step S42).

Therefore, a TCP session is opened between the distribution request part 15 of the encoder 10-2 and the distribution response part 26 of the decoder 20-1 (step S43).

In addition, suppose the terminal 50-1 makes distribution start instruction in the decoder 20-1 (step S3).

At that time, in the decoder 20-1, the step S21 restrains transmission of a distribution start request by the distribution request part 25. Therefore, the distribution request part 25 carries out distribution rejection notification to the terminal 50-1 (step S44).

As described above, in the present exemplary embodiment, in the case where another encoder 10-2 makes a distribution start request to the decoder 20-1 as well when the encoder 10-1 is distributing an audiovisual stream to the decoder 20-1 after the encoder 10-1 has made a distribution start request to the decoder 20-1, the decoder 20-1 rejects distribution to the encoder 10-2 which makes an distribution start request afterwards to, thereby enable arbitration among a plurality of distribution start requests.

In addition, in the case of receiving distribution start instruction again from the terminal 50-1, the decoder 20-1 can reject the distribution start instruction.

### (Distribution Start Requests From Both Encoder and Decoder)

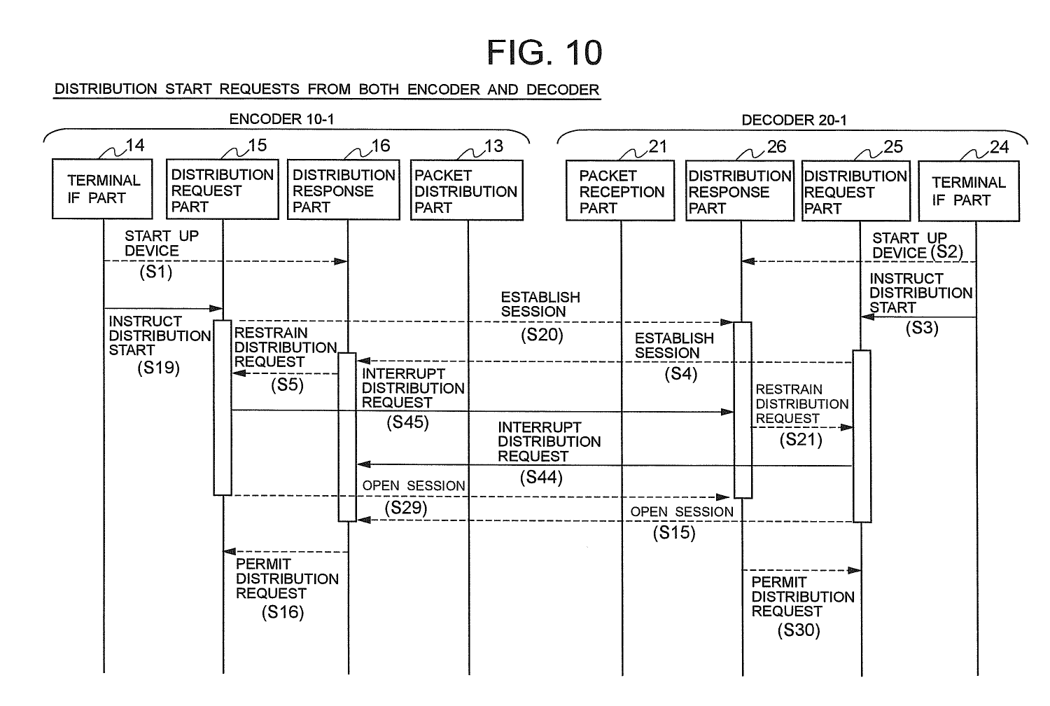

Next, operations in the case where an encoder and a decoder both make distribution start requests will be described. Here, with reference to FIG. 10, operations in the case where an encoder 10-1 and a decoder 20-1 both make a distribution start request mutually approximately at the same time will be described as an example.

At first, in the encoder 10-1, the distribution response part 16 enters a distribution start request wait state when its own device is started up (step S1).

Likewise, in the decoder 20-1, the distribution response part 26 enters a distribution start request wait state when its own device is started up (step S2).

Here, a TCP session is established between the distribution request part 25 of the decoder 20-1 and the distribution response part 16 of the encoder 10-1 (step S4) when a terminal 50-1 makes distribution start instruction in the decoder 20-1 (step S3).

In response, in the encoder 10-1, transmission of the distribution start request by the distribution request part 15 is restrained (step S5).

Approximately at the same time, when the terminal 40-1 makes distribution start instruction in the encoder 10-1, a TCP session is established between the distribution request part 15 of the encoder 10-1 and the distribution response part 26 of the decoder 20-1 (step S20).

In response, in the decoder 20-1, transmission of the distribution start request by the distribution request part 25 is restrained (step S21).

Transmission of the distribution start request by the distribution request part 25 was restrained in the decoder 20-1. Therefore, the distribution request part 25 notifies the encoder 10-1 of an interruption of the distribution start request (Step S44).

Subsequently, a TCP session is opened between the distribution request part 25 of the decoder 20-1 and the distribution response part 16 of the encoder 10-1 (step S15).

Likewise, transmission of the distribution start request by the distribution request part 15 is restrained in the encoder 10-1. Therefore, the distribution request part 15 notifies the decoder 20-1 of an interruption of the distribution start request (Step S45).

Subsequently, a TCP session is opened between the distribution request part 15 of the encoder 10-1 and the distribution response part 26 of the decoder 20-1 (step S29).

Thereby, the distribution start requests of both the decoder 20-1 and the encoder 10-1 will be temporarily reset.

Thereafter, in the decoder 20-1, transmission of the distribution start request by the distribution request part 25 is permitted (step S30). In the encoder 10-1, transmission of the distribution start request by the distribution request part 15 is permitted (step S19).

As described above, a second exemplary advantage according to the invention is that arbitration among a plurality of distribution start requests can be carried out by temporarily restraining transmission of a distribution start request in the case the encoder 10-1 and the decoder 20-1 both are mutually going to transmit distribution start requests approximately at the same time.

Here, in the present embodiment, a configuration with an encoder and a decoder mutually transmitting distribution start requests was described. However, the present invention will not be limited thereto. It goes without saying that the present invention is applicable to a configuration of transmitting distribution start requests mutually among a plurality of arbitrary information-processing devices.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information-processing device transmitting an audiovisual distribution start request mutually with another information-processing device to, thereby, start the audiovisual distribution or reception comprising:
a distribution request part that transmits the distribution start request to another information-processing device;
a distribution response part that transmits a distribution start response for the distribution start request from another information-processing device to the another information-processing device; and
a distribution control part that controls the distribution request part or the distribution response part upon start of the audiovisual distribution or reception to regulate transmission of the distribution start request or the distribution start response.

2. The information-processing device according to claim 1, wherein the distribution control part controls the distribution response part to restrain transmission of the distribution start response in the case where its own device transmits the distribution start request to start the audiovisual distribution or reception.

3. The information-processing device according to claim 1, wherein the distribution control part controls the distribution request part to restrain transmission of the distribution start request in the case where its own device transmits the distribution start response to start the audiovisual distribution or reception.

4. The information-processing device according to claim 1, wherein the distribution control part receives a distribution start request from another information-processing device besides the audiovisual distribution destination or distribution source and then controls the distribution response part to transmit a distribution rejection response to the another information-processing device in the case where its own device transmits a distribution start response to start the audiovisual distribution or reception.

5. The information-processing device according to claim 1, wherein the distribution control part controls the distribution request part to notify another information-processing device of instruction to interrupt transmission of the distribution start request in the case where the another information-processing device being a transmission destination of the distribution start request establishes a communication session with its own device, prior to transmission of the distribution start request from its own device.

6. The information-processing device according to claim 1, wherein the information-processing device is an encoder distributing the audio and video and the distribution start requests are mutually transmitted between the encoder and a decoder receiving the audio and video.

7. The information-processing device according to claim 1, wherein the information-processing device is a decoder receiving the audio and video and the distribution start requests are mutually transmitted between the decoder and an encoder distributing the audio and video.

8. An audiovisual distribution system including a plurality of information-processing devices that mutually transmit audiovisual distribution start requests to, thereby, start the audiovisual distribution or reception, wherein:
each of the plurality of information-processing devices comprises
a distribution request part that transmits the distribution start request to another information-processing device;
a distribution response part that transmits a distribution start response for the distribution start request from another information-processing device to the another information-processing device; and
a distribution control part that controls the distribution request part or the distribution response part upon start of the audiovisual distribution or reception to regulate transmission of the distribution start request or the distribution start response.

9. The audiovisual distribution system according to claim 8, wherein the distribution control part controls the distribution response part to restrain transmission of the distribution start response in the case where its own device transmits the distribution start request to start the audiovisual distribution or reception.

10. The audiovisual distribution system according to claim 8, wherein the distribution control part controls the distribution request part to restrain transmission of the distribution start request in the case where its own device transmits the distribution start response to start the audiovisual distribution or reception.

11. The audiovisual distribution system according to claim 8, wherein the distribution control part receives a distribution start request from another information-processing device besides the audiovisual distribution destination or distribution source and then controls the distribution response part to transmit a distribution rejection response to the another information-processing device in the case where its own device transmits the distribution start response to start the audiovisual distribution or reception.

12. The audiovisual distribution system according to claim 8, wherein the distribution control part controls the distribution request part to notify another information-processing device to interrupt transmission of the distribution start request in the case where the another information-processing device being a transmission destination of the distribution start request establishes a communication session with its own device, prior to transmission of the distribution start request from its own device.

13. The audiovisual distribution system according to claim 8, wherein
a plurality of the information-processing devices each comprises:
an encoder distributing the audio and video; and
a decoder receiving the audio and video distributed from the encoder and, wherein
the distribution start requests are mutually transmitted between the encoder and the decoder.

14. An audiovisual distribution method in an information-processing device including:
mutually transmitting audiovisual distribution start requests with another information-processing device to, thereby, start the audiovisual distribution or reception, wherein
the information-processing device includes:
a distribution request part transmitting the distribution start request to another information-processing device;
a distribution response part transmitting a distribution start response for the distribution start request from another information-processing device to the another information-processing device; and
a distribution control part controlling the distribution request part and the distribution response part, and the method comprising:
regulating transmission of the distribution start request or the distribution start response upon start of the audiovisual distribution or reception by the distribution control part.

15. The audiovisual distribution method according to claim 14, wherein the distribution control part controls the distribution response part to restrain transmission of the distribution start response in the case where its own device transmits the distribution start response to start audiovisual distribution or reception.

16. The audiovisual distribution method according to claim 14, wherein the distribution control part controls the distribution request part to restrain transmission of the distribution start request in the case where its own device transmits the distribution start response to start audiovisual distribution or reception.

17. The audiovisual distribution method according to claim 14, wherein the distribution control part receives the distribution start request from another information-processing device besides the audiovisual distribution destination or distribution source and then controls the distribution response part to transmit a distribution rejection response to the another information-processing device in the case where its own device transmits the distribution start response to start the audiovisual distribution or reception.

18. The audiovisual distribution method according to claim 14, wherein the distribution control part controls the distribution start request part to notify another information-processing device of instruction to interrupt transmission of the distribution start request in the case where the another information-processing device in the transmission destination of the distribution start request establishes a communication session with its own device prior to transmission of the distribution start request from its own device.

19. The audiovisual distribution method according to claim 14, wherein the information-processing device is an encoder distributing the audio and video and the distribution start requests are mutually transmitted between the encoder and a decoder receiving the audio and video.

20. The audiovisual distribution method according to claim 14, wherein the information-processing device is a decoder receiving the audio and video and the distribution start requests are mutually transmitted between the decoder and an encoder distributing the audio and video.

21. A recording medium that records a program for an audiovisual distribution method on an information-processing device mutually transmitting audiovisual distribution start requests with another information-processing device to, thereby, start the audiovisual distribution or reception, wherein
the information-processing device includes a distribution request part transmitting the distribution start request to another information-processing device; a distribution response part transmitting a distribution start response for the distribution start request from another information-processing device to the another information-processing device; a distribution control part controlling the distribution request part and the distribution response part; and a recording medium recording the program; and wherein
a program is stored in the recording medium for causing the distribution control part to regulate transmission of the distribution start request or the distribution start response upon start of the audiovisual distribution or reception.

22. An information-processing device transmitting an audiovisual distribution start request mutually with another information-processing device to, thereby, start the audiovisual distribution or reception comprising:
distribution request means that transmits the distribution start request to another information-processing device;
distribution response means that transmits a distribution start response for the distribution start request from another information-processing device to the another information-processing device; and
distribution control means that controls the distribution request means or the distribution response means upon start of the audiovisual distribution or reception to regulate transmission of the distribution start request or the distribution start response.

23. An audiovisual distribution system including a plurality of information-processing devices that mutually transmit audiovisual distribution start requests to, thereby, start the audiovisual distribution or reception, wherein
each of a plurality of the information-processing devices comprises:
distribution request means that transmits the distribution start request to another information-processing device;
distribution response means that transmits a distribution start response for the distribution start request from another information-processing device to the another information-processing device; and
distribution control means that controls the distribution request means or the distribution response means upon start of the audiovisual distribution or reception to regulate transmission of the distribution start request or the distribution start response.
